(19) United States
(12) Patent Application Publication
(10) Pub. No.: US 2025/0316414 A1
(43) Pub. Date: Oct. 9, 2025

(54) LANGSMITH DOUBLE NESTED RESONANCE COIL DESIGN FOR INCREASED MULTIPLE FIELD LINE GENERATIONS AND METHOD OF SAME

(71) Applicants: Richard Langsmith, Woodville, AL (US); Juliette Blythe, Woodville, AL (US); Alexander Langsmith, Woodville, AL (US)

(72) Inventors: Richard Langsmith, Woodville, AL (US); Juliette Blythe, Woodville, AL (US); Alexander Langsmith, Woodville, AL (US)

(21) Appl. No.: 18/629,900

(22) Filed: Apr. 8, 2024

(51) Int. Cl. H01F 27/26; H01F 27/28; H01F 41/02

(52) U.S. Cl. CPC H01F 27/263; H01F 27/2823; H01F 41/0206

(57) ABSTRACT

An electromagnetic coil design consisting of a series of nested electromagnetic coils where inner, middle, and outer electromagnetic coils are created that function separately from each other to generate magnetic field lines and temporarily generated north and south poles. The inner coil is placed or ‘nested’ within the middle coil which is then placed or ‘nested’ within the outer coil. When electric current is applied to the inner, middle, and outer coil simultaneously, each coil generates unique magnetic field lines. The design further increases the generation of magnetic resistance and force by adding additional magnetic field lines available for use in the same physical space.

### CROSS-REFERENCE TO RELATED APPLICATIONS

The present application by inventors Richard Langsmith, Juliette Blythe, and Alexander Langsmith is related to the co-pending application Ser. No. 18/607,545 titled LANGSMITH NESTED RESONANCE COIL DESIGN FOR MULTIPLE UNIQUE MAGNETIC FIELD LINE GENERATIONS AND METHOD OF SAME filed on Mar. 18, 2024 by inventors Richard Langsmith, Juliette Blythe, and Alexander Langsmith.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Richard Langsmith, Juliette Blythe, Alexander Langsmith

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

### Statement Regarding Prior Disclosures by the Inventor or a Joint Inventor

Not Applicable

### BACKGROUND OF THE INVENTION

Current or traditional ‘single’ electromagnetic coils consist of copper wire wound around a length of conductive magnetic material, often iron or steel. When electric current is applied to the wire, a magnetic field is generated. These magnetic fields follow the same pattern as permanent magnetics by having North and South poles. Electromagnetic coils with a single core and set of copper windings generate a finite number of magnetic field lines, limiting the efficiency and power of single electromagnetic coils. L-NRC ‘double’ electromagnetic coils increase the number of unique magnetic field lines generated within the same physical space as single electromagnetic coils. L-DNRC electromagnetic coil expands upon the principle of the L-NRC where the outer coil has sufficient space to house two nested coils, creating a ‘triple’ electromagnetic coil, further increasing the number of unique magnetic field lines generated within the same physical space as a ‘single’ or ‘double’ electromagnetic coil.

### TECHNICAL FIELD

The present invention conforms to the commonly accepted knowledge of magnetism as it relates to electric magnets and ‘single’ and ‘double’ electromagnetic coils. Electric motors are commonly made of multiple ‘single’ electromagnetic coils working in unison to interact with other ‘single’ electromagnetic coils or permanent magnets. However, to date, each electromagnetic coil is a single item functioning within the whole. While the L-NRC introduces a full second electromagnetic coil set within the first or ‘nested’, creating a double electromagnetic coil, the L-DNRC introduces a full third electromagnetic coil set ‘nested’ within the second full electromagnetic coil set that is then ‘nested’ within the first electromagnetic coil set. Each of the inner, middle, and outer electromagnetic coils generate their own unique magnetic field lines within the same space as the other, working together as a unit in the same space with exponentially more magnetic field lines available for use even further than the L-NRC.

The application of the L-DNRC electromagnetic coils extends to every electric motor or other application that is currently using traditional ‘single’ electromagnetic coils with the necessary space to house two additional electromagnetic coils. The conversion of ‘single’ electromagnetic coils to the L-DNRC will increase the efficiency of current electric motors from the increased number of magnetic field lines interacting with other electromagnetic coils and permanent magnets. Additional applications include new electric motors in development and future designs using electromagnetic coils.

L-DNRC coils also allow for the scalability of current and future electric motors. The creation of more magnetic field lines within the same physical space of the electromagnetic coils allows for electric motors to be made smaller while maintaining the same results. Conversely, if traditional ‘single’ electromagnetic coils are replaced directly with L-DNRC electromagnetic coils, the resulting output of the electric motor will increase.

The option of integration of L-DNRC coils into existing motors or conversion to full L-DNRC motors extends the applicable fields of us to include but not be limited to:
Advanced energy storage systems—Electric motors could play a key role in the storage and distribution of renewable energy by efficiently converting electrical energy to mechanical energy and vice versa.
Aerospace—electric motors used in all Aerospace related systems, transportation, satellites, habitation, robotics, power generation, UAV, UGV, UMG.
Appliances—Air conditioning, power tools, laundry equipment, kitchen appliances, vacuum cleaners, and electric fans.
Artificial muscles—Electric motors could be used in the development of artificial muscles for advanced prosthetics or humanoid robots, providing more natural, fluid motion.
Aviation—electric motors used in all Aviation related systems, aircraft, rotorcraft, robotics, power generation, UUV, UAV, and UUV/UAV cross overs.
Bio-inspired robots—Electric motors could power lifelike, agile robots inspired by animals and insects, capable of navigating challenging terrains and performing tasks that current robots cannot.
Climate control—Electric motors might be utilized in large-scale, innovative climate control systems designed to mitigate the effects of climate change, such as massive air purifiers or ocean-cleaning machines.
Entertainment—Electric motors are used in various entertainment systems like theme park rides, animatronics, and stage automation.
Exoskeletons—Wearable, powered exoskeletons for enhanced strength, mobility, and endurance in various fields such as construction, military, and medical rehabilitation.
Magnetic—field Induced Gravitational Manipulation for Cross-Dimensional Access-Corporate, military, and personal use to gather information or artifacts from similar yet separate extensions of reality
Magnetic—field Induced Gravitational Manipulation for Relative Temporal Shifts-Corporate, military, and personal use to gather information or artifacts from previous or future moments in time
Ground Transportation—Farm equipment, rail equipment, automotive, UGV, electric bikes, scooters, and electric buses.
Groundwork—Mining equipment, earth moving equipment, tunnel boring machines, construction machinery.
Machining/Milling/Drilling machines—CNC machines, lathes, milling machines, drilling machines, and other specialized machining equipment.
Marine—Ships, submersibles, UMV, drones, torpedoes, electric boats, and propulsion systems for underwater vehicles.
Medical equipment—MRI machines, X-ray machines, surgical robots, and various other medical devices.
Military—electric motors used in all Military related systems, ground vehicles, troop transportation vehicles, tanks, and various others.
Nanotechnology—Tiny electric motors may drive nanobots that perform tasks at the microscopic level, such as targeted drug delivery, tissue repair, or environmental cleanup.
Oil and gas equipment—Electric pumps, compressors, and other machinery used in the extraction, transportation, and processing of oil and gas.
Personal transport—Electric cars, trucks, vans, hoverboards, flying cars, and individual jetpacks powered by electric motors.
Renewable energy systems—Wind turbines, solar tracking systems, and hydroelectric generators.
Robotics and automation—Industrial robots, warehouse automation systems, and collaborative robots.
Space exploration—Advanced electric propulsion systems for interstellar travel, lunar and Mars rovers, and asteroid mining equipment.
Smart cities—Electric motors may drive various systems in smart cities, from efficient waste management solutions to automated public transportation networks.
Time travel devices—Electric motors are integral to time machines, allowing us to explore the past and future.
Virtual reality—Electric motors could be used in full-body haptic suits and motion simulators, creating a more immersive and realistic virtual reality experience.

### BRIEF SUMMARY

Current ‘single’ electromagnetic coils are limited in the quantity of magnetic field lines they generate. By adding additional electromagnetic coils within the same physical space of the original ‘single’ electromagnetic coil then multiple sets of magnetic field lines are generated and available for use. This ‘nesting’ application can be applied to electromagnetic coils no matter their shape to increase efficiency of existing and future motors.

### BRIEF DESCRIPTION OF DRAWINGS

FIG. 1 shows an outer coil of the L-DNRC showing the hollow space in the center.

FIG. 2 shows a middle coil of the L-DNRC showing the hollow space in the center.

FIG. 3 shows an inner coil of the L-DNRC.

FIG. 4 shows the inner coil of the L-DNRC partially nested within the middle coil of the L-DNRC partially nested within the outer coil of the L-DNRC.

FIG. 5 shows the inner coil of the L-DNRC fully nested within the middle coil of the L-DNRC fully nested within the outer coil of the L-DNRC.

FIG. 6 shows a representation of the multiple origin points of magnetic field lines on the nested inner, middle, and outer coils of the L-NRC.

FIG. 7 shows a second configuration of the L-DNRC inner, middle, and outer coils in partially nested positions.

### DETAILED DESCRIPTION OF DRAWINGS

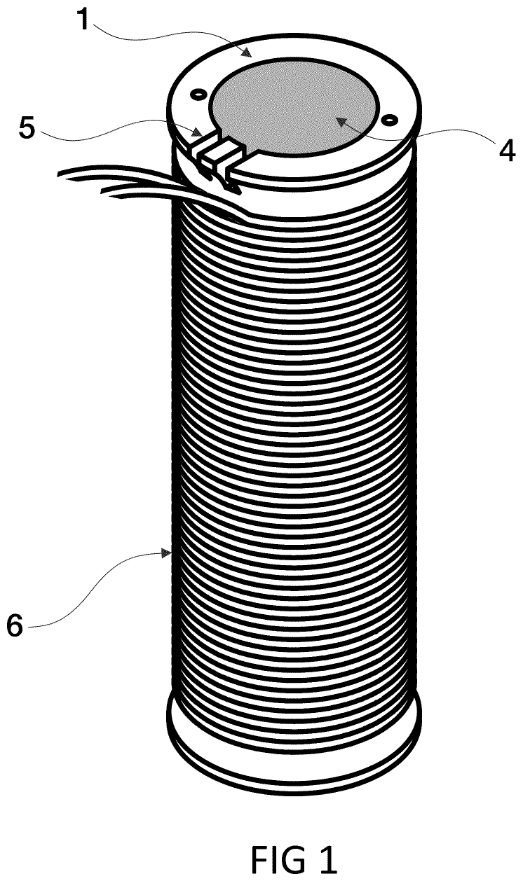

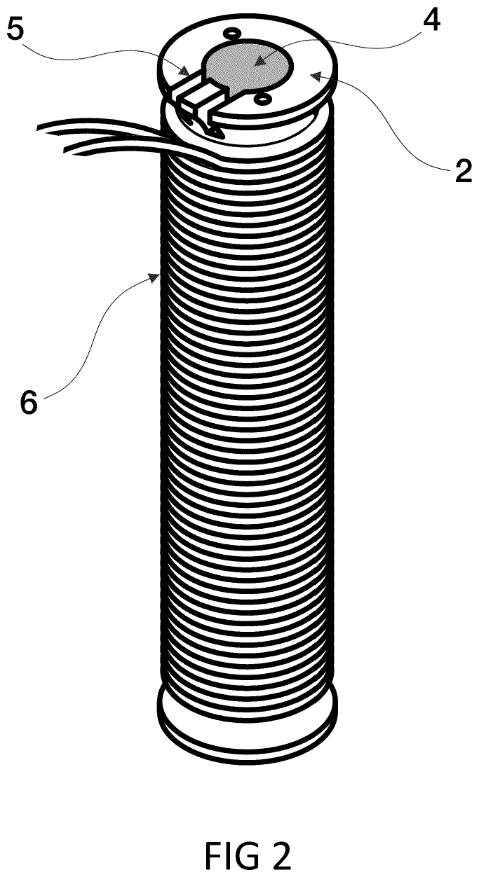

FIG. 1 shows the outer coil 1 of the L-DNRC where the copper wire windings 6 wrap around the length of the outer core with a hollow center space 4, that extends through the center of the outer core, to form the outer coil 1. Two wire grooves 5 are included in the top flange of the outer coil 1 for ends of the copper wire windings 6 of the middle coil 2 in FIG. 2 to extend through.

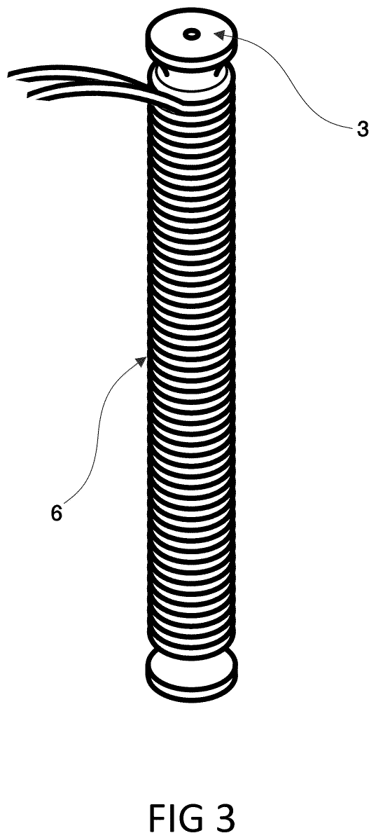

FIG. 2 shows the middle coil 2 of the L-DNRC where the copper wire windings 6 wrap around the length of the middle core with a hollow center space 4, that extends through the center of the middle core, to form the middle coil 2. Two wire grooves 5 are included in the top flange of the middle coil 2 for ends of the copper wire windings 6 of the inner coil 3 in FIG. 3 to extend through. The two ends of the copper wire windings 6 extend through the wire grooves 5 of the outer coil shown in FIG. 1.

FIG. 3 shows the inner coil 3 of the L-DNRC where the copper wire windings 6 wrap around the length of the inner core to form the inner coil 3. The two ends of the copper wire windings 6 extend through the wire grooves 5 of the middle coil 2 shown in FIG. 2.

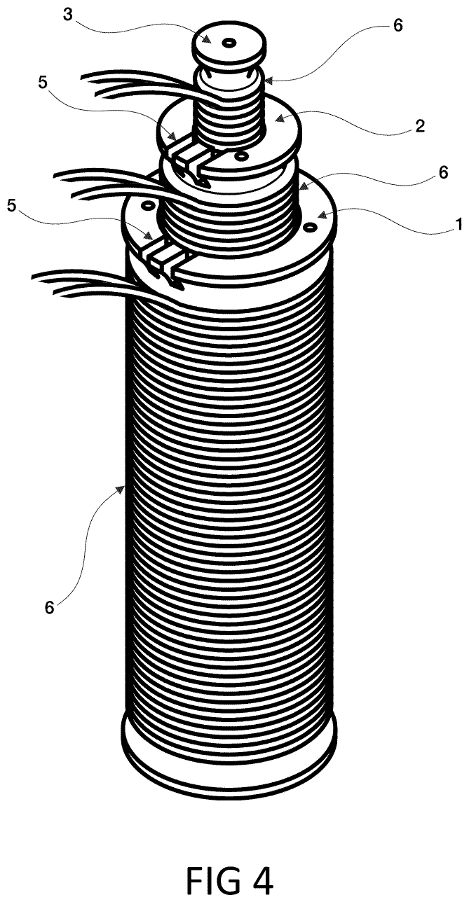

FIG. 4 shows the inner coil 3 of FIG. 3 partially nested within the middle coil 2 of FIG. 2, partially nested within the outer coil 1 of FIG. 1 where the copper wire windings 6 can be seen on the inner coil 3, the middle coil 2, and the outer coil 3.

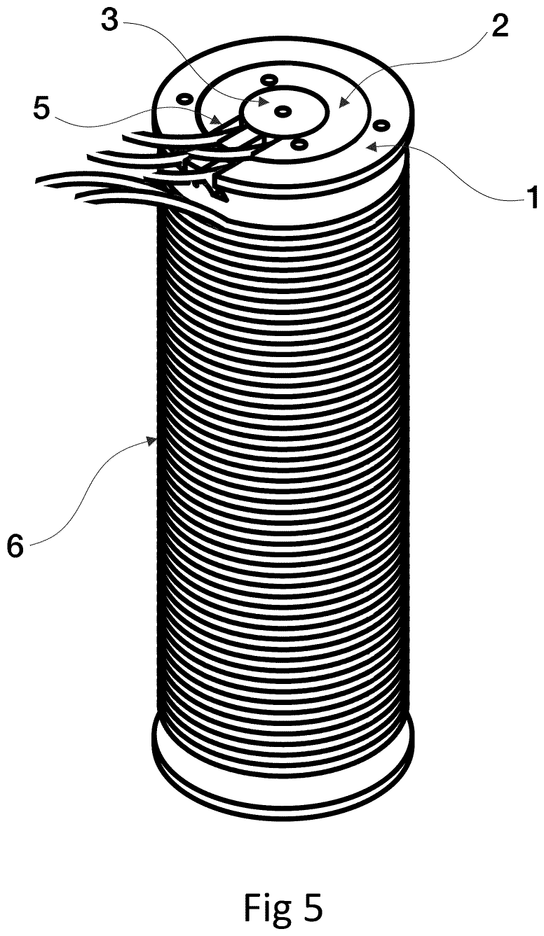

FIG. 5 shows the inner coil 3 of FIG. 3 fully nested within the middle coil 2 of FIG. 2, fully nested within the outer coil 1 of FIG. 1 where the copper wire windings 6 can be seen on the outer coil 3 and the copper wire windings 6 from the inner coil 3 are visibly protruding from the wire grooves 5 of the middle coil 2 and the copper wire windings 6 from the middle coil 2 are visibly protruding from the wire grooves 5 of the outer coil 1.

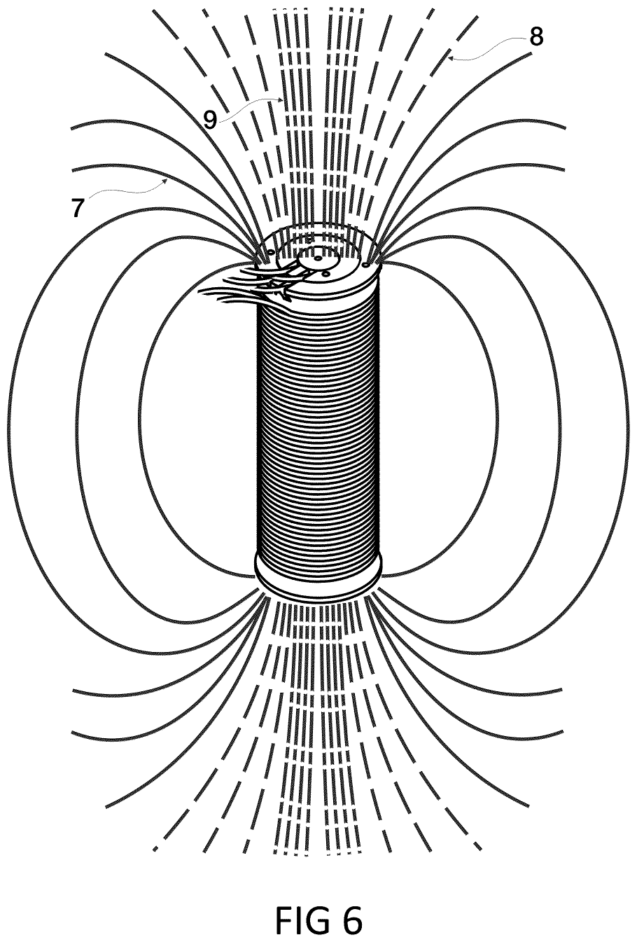

FIG. 6 shows portions of the magnetic field lines generated by the outer coil 1, the middle coil 2, and the inner coil 3.

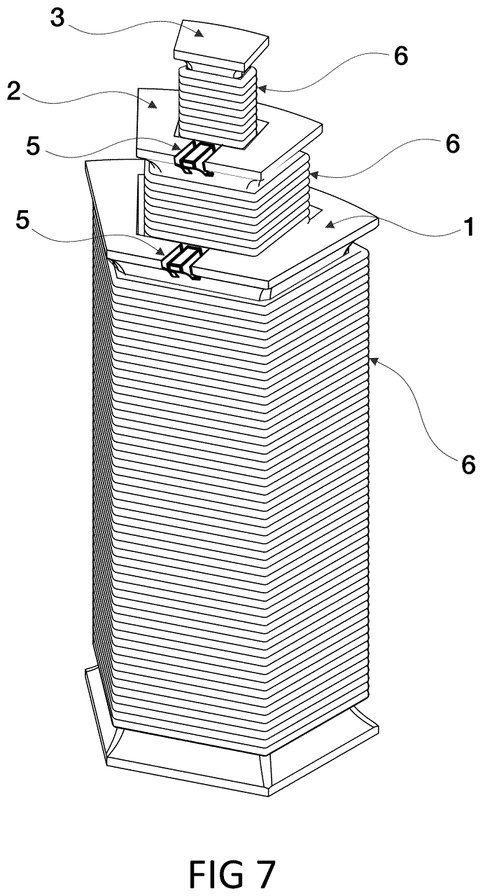

FIG. 7 shows a second configuration of the L-DNRC with an angled the inner coil 3 partially nested within the middle coil 2, partially nested within the outer coil 1 where the copper wire windings 6 can be seen on the inner coil 3, the middle coil 2, and the outer coil 3.

### LIST OF REFERENCE NUMERALS

1 Outer Coil
2 Middle Coil
3 Inner Coil
4 Hollow Space
5 Wire Grooves
6 Copper Wire Windings
7 Outer Coil Magnetic Field Lines
8 Middle Coil Magnetic Field Lines
9 Inner Coil Magnetic Field Lines

What is claimed is:

1. A L-DNRC nested electromagnetic coil comprising:
an outer electromagnetic coil comprising:
a core made of a ferrous material, most likely steel or iron; and
a plurality of copper wire windings extending the length of the core completed with a single continuous length of copper wire; and
a hollow portion in the core;
a middle electromagnetic coil comprising:
a core made of a ferrous material, most likely steel or iron; and
a plurality of copper wire windings extending the length of the core completed with a single continuous length of copper wire; and
a hollow portion in the core;
an inner electromagnetic coil comprising:
a core made of a ferrous material, most likely steel or iron; and
a plurality of copper wire windings extending the length of the core completed with a single continuous length of copper wire; wherein
an inner electromagnetic coil is nested within the hollow portion of a middle electromagnetic coil; and
a middle electromagnetic coil with an inner electromagnetic coil nested within the hollow portion of a middle electromagnetic coil is nested within the hollow portion of an outer electromagnetic coil.

2. The L-DNRC nested electromagnetic coil of claim 1 wherein the L-DNRC inner, middle, and outer coils are designed to generate, in response to the application of electric current to the copper coil windings, magnetic field lines.

3. The L-DNRC nested electromagnetic coil of claim 1 wherein the L-DNRC outer coil is designed to generate, in response to application of electric current to the copper coil windings, unique magnetic field lines independent of the activation of the L-DNRC inner and middle coils.

4. The L-DNRC nested electromagnetic coil of claim 1 wherein the L-DNRC middle coil is designed to generate, in response to application of electric current to the copper coil windings, unique magnetic field lines independent of the activation of the L-DNRC inner and outer coils.

5. The L-DNRC nested electromagnetic coil of claim 1 wherein the L-DNRC inner coil is designed to generate, in response to application of electric current to the copper coil windings, unique magnetic field lines independent of the activation of the L-DNRC middle and outer coils.

6. The L-DNRC nested electromagnetic coil of claim 1 wherein the size of the L-DNRC's are increased or decreased as needed.

7. The L-DNRC nested electromagnetic coil of claim 1 wherein the gauge of the copper wire comprising the copper windings of the outer electromagnetic coil and inner electromagnetic coil is variable depending on the needs and specifications of the specific coil requirements.

8. Wherein existing electromagnetic coils can be converted into the L-DNRC nested electromagnetic coil of claim 1.

9. The L-DNRC nested electromagnetic coil of claim 1 wherein the shape of the inner, middle, and outer coils can be changed as needed.

10. The L-DNRC nested electromagnetic coil of claim 1 wherein the shape of the outer, middle, and inner coils can be different.

11. The L-DNRC nested electromagnetic coil of claim 1 wherein the magnetic field lines of the inner, middle, and outer coils are unique from the magnetic field lines of the other coils.

12. The L-DNRC nested electromagnetic coil of claim 1 wherein the magnetic field lines of the inner, middle, and outer coils follow a different sequence of activation than the other coils.

13. The L-DNRC nested electromagnetic coil of claim 1 wherein the magnetic field lines of the inner, middle, and outer coils follow the same sequence of activation as the other coils.

14. The L-DNRC nested electromagnetic coil of claim 1 wherein the total number of magnetic field lines includes the unique magnetic field lines of the inner coil combined with the unique magnetic field lines of the middle coil combined with the unique magnetic field lines of the outer coil.

15. A method for increased generation of multiple unique magnetic field lines within the same space, said method comprising:
measuring the total available space for the electromagnetic coil;
shaping an outer core made of ferrous material, most likely steel or iron, into a desired shape and length to fit within the measured space;
boring a hole in the center of the outer coil core slightly larger than the desired diameter of the middle coil;
shaping a middle coil made of ferrous material, most likely steel or iron to fit within the bored hole of the outer coil;
boring a hole in the center of the middle coil core slightly larger than the desired diameter of the inner coil;
shaping an inner core made of ferrous material, most likely steel or iron, to fit within the bored hole in the middle coil;
winding a single continuous length of copper wire around the length of the outer core;
winding a single continuous length of copper wire around the length of the middle core;
winding a single continuous length of copper wire around the length of the inner core;
inserting the inner core with copper windings into the middle core with copper windings;
maintaining position of the inner core with copper windings within the middle core with copper windings, insert the middle core with copper windings into the outer core;
attaching the ends of the inner core copper windings to a control device;
attaching the ends of the middle core copper windings to a control device;
attaching the ends of the outer core copper windings to a control device;
applying electrical current to the inner core copper windings through a control mechanism;
applying electrical current to the middle core copper windings through a control mechanism; and
applying electrical current to the outer core copper windings through a control mechanism.

16. The method of claim 10 wherein the inner, middle, and outer core copper windings control devices are different from the control device of the others.

17. The method of claim 10 wherein the inner middle, and outer core copper windings control device is the same as the control device of the others.

18. The method of claim 10 wherein the inner, middle, and outer core copper windings receive electrical currents different sequences.

19. The method of claim 10 wherein the inner, middle, and outer core copper windings receive electrical currents in the same sequence as the others.

20. The method of claim 10 wherein the cutting of wire groves for the placement of copper wire ends from the inner coil and middle coil is required on the middle and outer coils.

21. A method for adding nested electromagnetic coil to existing electromagnetic coils, said method comprising:
removing of existing electromagnetic coil from current apparatus;
boring a hole in the center of existing electromagnetic coil wherein the diameter of the bored hole is slightly larger than the middle electromagnetic coil;
shaping a middle coil made of ferrous material, most likely steel or iron to fit within the bored hole of the existing electromagnetic coil;
boring a hole in the center of the middle coil core slightly larger than the desired diameter of the inner coil;
shaping an inner core made of ferrous material, most likely steel or iron, to fit within the bored hole in the middle coil;
winding a single continuous length of copper wire around the length of the middle core;
winding a single continuous length of copper wire around the length of the inner core;
inserting the inner core with copper windings into the middle core with copper windings;
inserting the middle electromagnetic coil with the inner electromagnetic coil nested within the middle electromagnetic coil, matching the shape of the bored hole, into the newly created hollow portion of the existing electromagnetic coil;
replacing and reattaching the now nested electromagnetic coil into the current apparatus; and
attaching the ends of the copper windings of the middle and inner coils to the control mechanism of the current apparatus.

22. The method of claim 21 where the existing electromagnetic coil becomes the outer coil.
